(19) United States
(12) Patent Application Publication
(10) Pub. No.: US 2025/0005654 A1
(43) Pub. Date: Jan. 2, 2025

(54) MODIFYING RANKINGS OF ITEMS IN SEARCH RESULTS BASED ON ITEM AVAILABILITIES AND SEARCH QUERY ATTRIBUTES

(71) Applicant: Maplebear Inc. (dba Instacart), San Francisco, CA (US)

(72) Inventors: Raochuan Fan, Sunnyvale, CA (US); Prakash Putta, Seattle, WA (US); Vinesh Reddy Gudla, South San Francisco, CA (US); Nkemakonam Paulet Okoye, Bellevue, WA (US); Taesik Na, Issaquah, WA (US); Tejaswi Tenneti, San Carlos, CA (US)

(21) Appl. No.: 18/217,329

(22) Filed: Jun. 30, 2023

(51) Int. Cl. G06Q 30/0601

(52) U.S. Cl. CPC G06Q 30/0641

(57) ABSTRACT

An online concierge system allows a customer to search items offered by a retailer by providing a set of items to the customer based on a search query. To account for varying availability of items at the retailer, the online concierge system modifies rankings in the set of items having less than a threshold predicted availability at the retailer. This reduces a likelihood selection of an item likely to be unavailable at the retailer. To maintain customer confidence in the items selected based on the search results by maintaining visibility of items relevant to the search query, the online concierge system determines how much an item is modified within the set based on search query attributes, item attributes, or customer characteristics. This allows different items to be adjusted different amounts in a set based on the item, as well as the search query for which the item was selected.

### BACKGROUND

Online concierge systems receive orders for items from customers and provide an order to a picker (or a shopper), who fulfills the order. To fulfill an order, a picker to whom the order was allocated obtains items in the order from a retailer. The picker subsequently delivers the obtained items to a customer.

An application associated with the online concierge system executing on a customer client device and receives input from a customer for creating an order. For example, the application receives one or more search queries from a customer and receives search results comprising items satisfying a search query from the online concierge system. The items received from the online concierge system based on the search query each have one or more attributes that at least partially match the search query received from the application.

When determining which search results to display in response to a search query, the online concierge system may account for availabilities of those items at the retailer. For example, if items are shown prominently in the search results even though they are unavailable at the retailer, the user may attempt to order an unavailable item and thereby have a bad experience with the system. However, if items that are unavailable are not shown, even though the user knows that the items are normally carried by eth retailer, the user's trust in the system may suffer. Such decreased trust in search results reduces subsequent interaction by the customer with the online concierge system or reduces a number of items the customer includes in one or more orders.

### SUMMARY

In accordance with one or more aspects of the disclosure, an online concierge system receives an identifier of a retailer from a customer and retrieves a catalog corresponding to the identified retailer. The catalog includes items offered by the retailer and includes item attributes for each item offered by the retailer. After the customer identifies the retailer, the online concierge system receives a search query from the customer. The search query comprises one or more words, phrases, or characters. In some embodiments, the online concierge system receives the search query through an ordering interface presented to the customer in response to the online concierge system receiving a request to create an order for fulfillment at the identified retailer.

The online concierge system selects a set of items based on the search query as search results for the search query. Each item of the set has at least one item attribute at least partially matching the search query. While selecting the set of items reduces a number of items offered by the retailer presented to the customer based on the search query, finding, or selecting a specific item from the set may be time consuming for the customer.

To further simplify identification of a specific item from the set of items, the online concierge system generates a ranking for the set of items that specifies an order in which items of the set are presented when the set of items is displayed. The ranking has multiple positions, with each item of the set having a position specifying a location in an interface where the item is displayed. In various embodiments, the online concierge system determines the ranking based on a relevance score between each item of the set and the search query. The ranking score for an item of the set may be based on one or more of: a probability of the customer including the item in an order, an amount of the search query matched by one or more item attributes, a number of prior orders from the customer including the item, or other information describing the item or interactions by customers with the item. The online concierge system ranks items of the set based on their relevance scores, with items having larger ranking scores having higher positions in the ranking. This positioning presents items having higher relevance scores in more prominent positions, so they are more readily identifiable by the customer.

However, different items of the set have different availabilities at the identified retailer. As the online concierge system obtains items for fulfilling an order from the customer from the identified retailer, availability of an item at the identified retailer affects capability of the online concierge system fulfilling an order. To account for availability of items when presenting items of the set to the customer, the online concierge system determines a predicted availability for each item of the set at the identified retailer. In various embodiments, the online concierge system applies a trained availability model to item attributes of an item, a time when the search query was received, and the identifier of the identified retailer, with the trained availability model outputting a predicted availability of the item. Alternatively, the online concierge system requests an inventory of an item from the identified retailer when generating the set of items and receives a current inventory of the item from the identified retailer to determine the predicted availability of the item at the retailer.

The online concierge system identifies one or more items of the set having a predicted availability that does not exceed a threshold predicted availability (or having a predicted availability less than the threshold predicted availability). In various embodiments, the online concierge system determines the threshold predicted availability based on prior feedback from customers for prior orders or based on other information describing user satisfaction or reaction to orders. The threshold predicted availability may be specific to the customer from whom the search query was received or may be applied to global customers of the online concierge system.

To account for the predicted availability of an identified item of the set being less than the threshold predicted availability, the online concierge system determines a position modification for the identified item to decrease a position in the ranking of the identified item. In some embodiments, the position modification specifies a number of positions in the ranking by which the identified item is decreased, while in other embodiments the position modification indicates a specific position in the ranking for the identified item. When determining the position modification for an identified item, the online concierge system accounts for one or more of: search query attributes of the search query, item attributes of the identified item, and customer characteristics of the customer. This allows the position modification for an item to account for various factors relevant to selection of the set of items, providing an item- and context-specific reduction in the ranking for the identified item. Accounting for context in which the set of items was selected enables the identified item to be decreased in the ranking to reduce a likelihood of the identified item being selected, while preventing the identified item having a reduced position in the ranking causing the customer to lose confidence in the selection of items based on the search query.

In some embodiments, the online concierge system applies a trained position modification model to one or more of: search query attributes of the search query, item attributes of the identified item, and customer characteristics of the customer from whom the search query was received. In other embodiments, the online concierge system determines the position modification for an identified item by applying one or more rules to one or more combinations of values of the search query attributes for the search query, the item attributes for the identified item, and the customer characteristics of a customer from whom the search query was received. Different rules include different combinations of values for search query attributes, item attributes, and customer characteristics, with a rule specifying a position modification corresponding to a particular combination of values for search query attributes, item attributes, and customer characteristics.

An example search query attribute is query entropy of the search query providing a measure of the breadth of the search query relative to a diversity of items included in the catalog for the identified retailer. Other information describing the search query may be alternatively or additionally be used. Example item attributes of an item include a relevance score for a combination of the item and the search query, a length of time the item has been included in the catalog for the retailer an amount of the search query matched by one or more other item attributes, and an indication whether the item was previously included in one or more prior orders received from the customer. Example customer characteristics include a type of customer client device from which the search query was received and an amount of time the user has maintained an account with the online concierge system.

Determining the position modification for the identified item based on search query attributes, item attributes, and customer characteristics, allows different position modifications to be determined for different items when different search queries are received. This dynamic determination of a position modification for an identified item allows a number of positions the identified item is reduced in a ranking to vary for different search queries, for different items, or for different customers. Such tailoring of an amount by which the identified item is decreased in a ranking decreases a likelihood of the customer including the item in an order, while enabling the customer to locate the item within a set of items selected based on the search query. Allowing the customer to still locate the identified item within the set of search results without significant input preserves customer confidence selection of items based on the search query by the online concierge system, increasing a likelihood of subsequent interaction with the online concierge system by the customer.

The online concierge system modifies the ranking of the set of items by decreasing a position of the identified item based on the determined position modification. When modifying the ranking, the identified item is repositioned to a lower position in the ranking identified from the position modification, while positions of items initially below the identified item in the ranking are increased. The online concierge system transmits the modified ranking to a customer client device for display to the customer in an order determined by the modified ranking. This allows the customer to identify items expected to be in the set by the customer, while reducing a likelihood of the customer selecting an item having a predicted availability that does not exceed the predicted availability for an order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for generating search results displaying items offered by a retailer accounting for predicted availabilities of items and search query attributes of a search query, in accordance with one or more embodiments.

FIG. 4 is a process flow diagram of a method for generating search results displaying items offered by a retailer accounting for predicted availabilities of items and search query attributes of a search query, in accordance with one or more embodiments.

### DETAILED DESCRIPTION

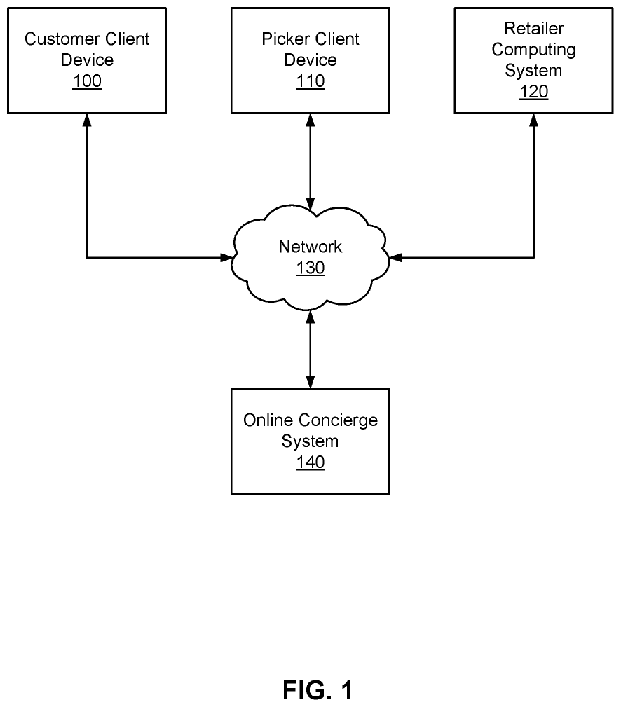

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding, or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

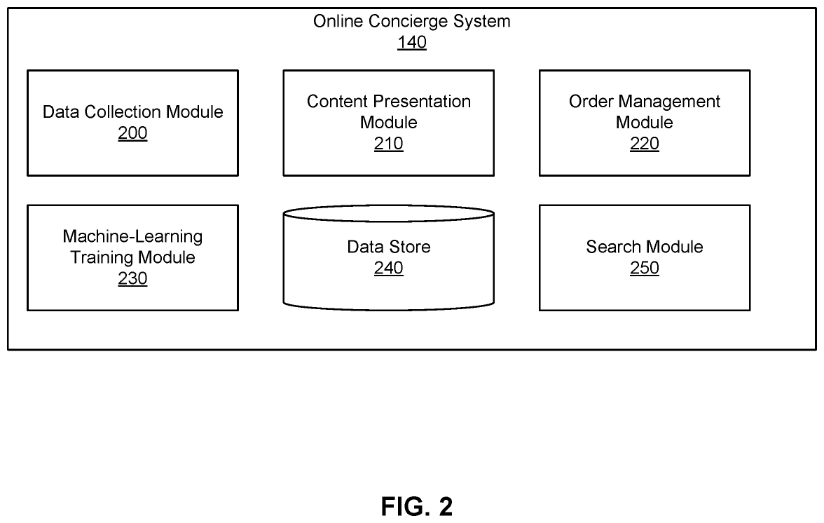

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

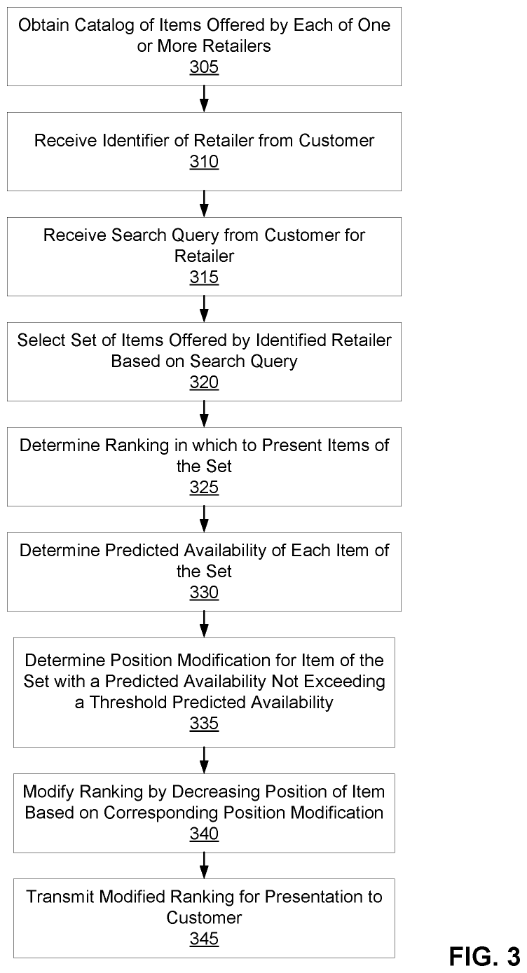

In various embodiments, the machine learning training module 230 trains a position modification model based on interactions with sets of items displayed to customers in response to search results. The machine learning training module 230 generates training examples including a position of an item of a set in a ranking of the set, search query attributes of the search query for which the set was selected, item attributes of the item, and characteristics of a customer from whom the search query was received. A label applied to a training example indicates whether the customer performed a specific action with the set of items when displayed. For example, the label indicates whether the customer included at least one item of the set in an order. The position modification model is trained to predict a probability of a customer performing the specific action with the set of items when an item with specific item attributes has a position in a ranking of the set. As further described below in conjunction with FIG. 3, the position modification model trains the position modification model through application to each of a set of training examples. The machine learning training module 230 scores the output from the position modification model relative to a label for a corresponding training example using a loss function. The machine learning training module 230 updates one or more parameters of the position modification model based on the score.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

The search module 250 selects one or more items from a catalog for a retailer based on a search query received from a customer. The search module 250 retrieves a catalog from the data store 240 corresponding to a retailer identified by the customer and selects a set of items from the catalog based on the search query. Each item selected based on the search query includes one or more item attributes at least partially matching the search query. The set of items selected by the search module 250 for the search query comprise a set of search results for the search query. In various embodiments, the search module 250 employs a search engine that selects items with item attributes at least partially matching the search query and determines a ranking of the selected items, as further described below in conjunction with FIG. 3. The selected items are displayed in an order based on the ranking, with positions in the ranking of selected items corresponding to relative locations where different selected items are presented to the customer.

To account for varying availabilities of items offered by a retailer when determining the ranking of a set of items comprising search results, the search module 250 determines a position modification for an item of the set having a predicted availability at the retailer that does not exceed a threshold predicted availability. The position modification for the item specifies an amount by which a position of the item in a current ranking is decreased or specifies a lower position in a than a position of the item in a current ranking. Decreasing the position in the ranking of an item reduces a likelihood of a customer selecting the item for inclusion in an order, which reduces a likelihood of the order including an item that is not available at a retailer. However, a customer may lose confidence in the search results from the search module 250 if certain items relevant to a search query are difficult to locate within search results.

For an item in a set of search results identified as having a predicted availability that does not exceed a threshold predicted availability, the search module 250 determines the position modification for the identified item based on one or more of: search query attributes of the search query, item attributes of the item, and customer characteristics of the customer. For example, the machine learning training module 230 trains a position modification model to determine a position modification for an item based on item attributes of the item, search query attributes of a search query causing selection of the item, and customer characteristics of a customer from whom the search query was received, as further described below in conjunction with FIG. 3. Alternatively, the search module 250 maintains various rules, with each rule including a position modification and one or more criteria for a combination of search query attributes, item attributes, and customer characteristics. For a combination of an item and a search query, the search module 250 selects a rule having a threshold number of criteria satisfied by corresponding item attributes, search query attributes, or customer characteristics. The search module 250 applies the position modification from the selected rule to the item in a ranking of a set of search results, as further described below in conjunction with FIG. 3. Alternatively, a ranking model trained by the machine learning module 230 to rank items selected based on a search query accounts for one or more of search query attributes, item attributes, and customer characteristics when ranking a set of items comprising search results. Determining the position modification for an item included in a set of search results based on search query attributes, item attributes, and customer characteristics, allows the item to remain identifiable in search results to a customer from whom a search query was received while reducing a likelihood of the customer including the item in an order.

FIG. 3 is a flowchart for a method for generating search results displaying items offered by a retailer accounting for predicted availabilities of items at the retailer and search query attributes of a search query, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 obtains 305 a catalog of items offered by each of one or more retailers. In various embodiments, the online concierge system 140 transmits a request to a retailer for a catalog of items offered by the retailer. The retailer transmits information identifying items offered by the retailer and item attributes of each of the items. The online concierge system 140 stores the received catalog in association with an identifier of the retailer in a data store 240, as further described above in conjunction with FIG. 2. In various embodiments, the catalog includes multiple entries, with each entry corresponding to a different item. An entry in the catalog includes an item identifier of the item and one or more item attributes of the item. Example item attributes of an item include: one or more keywords, a brand offering the item, a manufacturer of the item, a type of the item, a price of the item, a quantity of the item, a size of the item and other descriptive information of the item. Additionally, one or more item attributes may be specified by the online concierge system 140 for an item based on information from the retailer and included in an entry of the catalog for the item by the online concierge system 140. Example item attributes specified by the online concierge system 140 for an item include: a category for the item, one or more sub-categories for the item, and any other suitable information for the item.

With catalogs obtained 305 and stored for one or more retailers, the online concierge system 140 receives 310 an identifier of a retailer from a customer. For example, the identifier of the retailer is included in a request from the customer to create an order received 310 by the online concierge system 140. As another example, the customer selects a retailer to search for items and transmits a request to the online concierge system 140 including the identifier of the retailer. In another example, the online concierge system 140 receives 310 a request to browse a retailer from a customer, with the request including an identifier of the retailer.

The online concierge system 140 retrieves a catalog associated with the identifier of the retailer received 310 from the customer, identifying items offered by the retailer corresponding to the received identifier. After identifying the retailer, the online concierge system 140 receives 315 a search query from the customer. The search query includes one or more words or phrases. For example, the customer provides one or more words or phrases for the search query via an ordering interface presented to the customer by a customer client device 100.

Based on the search query, the online concierge system 140 selects 320 a set of items from the catalog for the identified retailer. The set of items comprises search results where each item of the set has at least one or more item attributes that at least partially match the search query. For example, each item selected 320 for the set has at least one item attribute at least partially matching the search query. Selecting 320 the set of items from the search query reduces a number of items offered by the retailer for presentation to the customer, simplifying identification of items offered by the retailer by reducing a number of items offered by the retailer presented to the customer.

To further simplify selection of items by the customer, the online concierge system 140 determines 325 a ranking of items of the set, which specifies an order in which items of the set are displayed to the customer in search results included in an interface. In various embodiments, to determine 325 the ranking of items of the set are displayed, the online concierge system 140 determines a relevance score for each item of the set to the search query. For example, the online concierge system 140 applies a ranking model to the search query and to information describing each item of the set. The ranking model outputs the relevance score for an item to the search query, with the relevance score based on an amount of information describing the item matched by the search query in some embodiments. The relevance score may also account for a probability of the customer including the item in an order in some embodiments. For example, for each selected item, the online concierge system 140 determines a probability of the user including the selected item in an order, or purchasing the selected item, by applying a trained purchase model to the customer and to the selected item. The online concierge system 140 uses the probability of the customer purchasing the selected item as the relevance score for the selected item in some embodiments.

Additionally, or alternatively, the online concierge system 140 may account for prior inclusion of a selected item in orders previously received from the customer (e.g., a number of prior orders from the customer including the selected item, a frequency with which prior orders from the customer included the selected item) when determining the relevance score for the selected item. In other embodiments, the online concierge system 140 determines the relevance score for a selected item based on the probability of the user purchasing the selected item and an amount of the search query matching one or more item attributes of the selected item. Additionally, the relevance score for a selected item accounts for inclusion of the selected item in orders received from various users or selection of the selected item by various users of the online concierge system 140, allowing the online concierge system 140 to determine an organic score for a selected item that accounts for popularity of the selected item among users of the online concierge system 140. The online concierge system 140 combines a probability of the customer purchasing the selected item and the organic score for the selected item to determine the relevance score for the selected item in various embodiments.

Based on the relevance score for each item of the set, the online concierge system 140 determines 325 the ranking of the items of the set. Each item of the set has a position in the ranking, and the online concierge system 140 displays items of the set in a position of an interface corresponding to its position in the ranking. Items with higher relevance scores have higher positions in the ranking, so an item with the highest position in the ranking has a maximum relevance score and an item with a lowest position in the ranking has a minimum relevance score. As the relevance score for an item accounts for a probability of the customer including the item in an order (or an amount of one or more item attributes of the item matching the received search query) items more likely to be purchased (or with item attributes matching a greater amount of the search query) have higher positions in the ranking, making those items more easily visible to the customer when displaying the set of items.

While determining 325 the ranking of items based on relevance scores to the search query allows the customer to more easily identify items likely to be purchased or having an increased amount of one or more item attributes matching the search query, conventional ranking models do not account for varying availability of items at the identified retailer. As the online concierge system 140 fulfills orders from retailers, availability of an item at the identified retailer affects fulfillment of an order by a picker for the online concierge system 140. Variances in availability of items at a retailer may cause items with higher positions in the ranking to be unavailable, despite being easier to identify from the ranking, potentially causing inclusion of an item unavailable from the identified retailer but having a high position in the ranking of the set of items in an order. Inclusion of a highly ranked item of the set in an order when the highly ranked item has limited availability at the identified retailer decreases a likelihood of the online concierge system 140 successfully fulfilling the order. Such decreased likelihood of order fulfillment reduces the customer's subsequent interaction with the online concierge system 140.

To account for predicted availability of one or more items of the set at the retailer when determining 325 the ranking of the items of the set, the online concierge system 140 determines 330 a predicted availability of each item of the set at the identified retailer. In some embodiments, the online concierge system 140 determines 330 the predicted availability of an item based on inventory information received from the identified retailer. For example, a retailer periodically transmits a number of items in-stock at the retailer to the online concierge system 140, which updates the catalog based on the information received from the retailer. In other embodiments, the online concierge system 140 transmits a request for an inventory level of an item to a retailer and receives a current inventory level of the item from the retailer in response to the request.

In other embodiments, the online concierge system 140 applies a trained availability model to each item of the set, with the trained availability model determining 330 a predicted availability of an item based on item attributes. The predicted availability of the item specifies a likelihood of the item being available at the retailer. In various embodiments, the availability model receives an item identifier of an item, item attributes of the item, an identifier of a retailer, and a time for obtaining the item from the retailer. Alternatively, the availability model receives a combination of an item identifier and an identifier of a retailer as inputs. During a training process, the availability model is applied to a set of availability training examples, with each availability training example including information identifying a combination of an item and a retailer (and may include other information, such as a time for obtaining the item from the retailer). A label is applied to each availability training example indicating whether the item was available at the retailer. For example, the label has a specific value indicating the item was available at the retailer and has an alternative value when the item was not available at the retailer. A label applied to an availability training example is based on information received from a picker indicating whether an item was available at a retailer in various embodiments.

The availability model comprises a set of weights that are parameters used by the availability model to transform input data identifying an item and a retailer into a likelihood of the item being available at the retailer. To determine the weights for the availability model, the online concierge system performs a training process that may include: applying the availability model to an availability training example, comparing an output of the availability model to the label associated with the availability training example to generate a score, and updating weights comprising the availability model through a back-propagation process based on the score. The weights may be stored on one or more computer-readable media. After the training process, the online concierge system 140 applies the stored weights to received combinations of items and retailers to determine a predicted availability of an item at a retailer.

Based on the predicted availabilities of different items of the set, the online concierge system 140 identifies one or more items having a predicted availability that does not exceed a threshold predicted availability. In some embodiments, the online concierge system 140 identifies each item of the set with a predicted availability that does not exceed the threshold predicted availability. Alternatively, the online concierge system 140 identifies each item of the set having at least a threshold position in the ranking and having a predicted availability that does not exceed the threshold predicated availability. The threshold predicted availability is determined and maintained by the online concierge system in various embodiments.

To account for a predicted availability of an item not exceeding the threshold predicted availability when ranking items of the set, the online concierge system 140 determines 335 a position modification for one or more items of the set having less than a threshold predicted availability. The position modification decreases a position in the ranking of an item with a predicated availability that does not exceed the threshold predicted availability. Reducing the position of an item in response to the item's predicted availability not exceeding the threshold predicted availability makes the item less visible to the customer in the ranking, while maintaining inclusion of the item in the set of items that are search results for the received search query. The online concierge system 140 may determine 335 a position modification for each item of the set identified as having a predicted availability that does not exceed the threshold predicted availability. Alternatively, the online concierge system 140 determines 335 a position modification for each item of the set having at least a threshold position in the ranking and having a predicted availability that does not exceed the threshold predicted availability.

As the predicted availability of different items of the set may differently affect a likelihood of the customer selecting an item or selecting an alternative item, the online concierge system 140 accounts for one or more search query attributes and one or more item attributes of an item when determining 335 the position modification for an item. The search query attributes and the item attributes affect a value of the position modification for the item. Accounting for different factors allows the online concierge system 140 to determine different position modifications for different items, for different customers, for different received search queries, and for different combinations of items, customers, and search queries. Search query attributes describe the search query, while item attributes describe the item or matching between various item attributes and the search query. In various embodiments, the online concierge system 140 also accounts for one or more customer characteristics of the customer. Accounting for search query attributes, as well as item attributes or customer characteristics, in addition to a predicted availability of an item at a retailer allows more granular determination of position modifications for different items, for different users, or for different search queries.

A search query attribute for determining 335 the position modification for an identified item in various embodiments is a query entropy relative to the catalog for the identified retailer. The query entropy represents an estimated breadth of the search query relative to a diversity of items in the catalog for the identified retailer. The online concierge system 140 determines the query entropy for the search query based on a diversity of items that are observed to be or are predicted to be associated with a customer performing a specific interaction (e.g., including an item in an order, requesting additional information about an item) in response to the search query. For a particular retailer, broad search queries will generally have relatively higher query entropies because there may be a wide range of items included in search results for a search query that are reasonably likely to result in the customer performing the specific action (e.g., including an item in an order). For example, a broad search query for a retailer, such as “snacks,” is reasonably likely to result in a customer including an item in an order, as the corresponding search results include a wide range of items with various item attributes (e.g., different types of snacks, different flavors, different brands, different sizes, etc.). In contrast, a relatively narrow search query for the same retailer as in the previous example will generally have a relatively lower query entropy as corresponding search results include a relatively small number of items that are reasonably likely to result in a customer performing the specific action. For example, a narrow search of “20 oz Potato Man's spicy barbecue potato chips baked,” results in a single item or a small number of closely related items that are likely to result in a customer performing the specific action.

A search query may have a different query entropy when used to search catalogs from different retailers, depending on the diversity of items included in the catalogs for the different retailers. For example, a search query of “soap” may represent a relatively broad search with a high query entropy with respect to a retailer including a wide range of soap products (e.g., a large bath and beauty store). However, the search query of “soap” may represent a narrower search having a relatively lower query entropy when used to search a catalog of a retailer with a limited number of soap products (e.g., a small gift shop).

In one or more embodiments, the online concierge system 140 determines the query entropy for a search query based on historical data associated with historical search queries and historical performance of the specific action by customers associated with those historical search queries with respect to a given retailer. For example, the online concierge system 140 obtains data for a search query indicating a number of occurrences of the specific action by one or more customers for each of a set of different items comprising search results for the search query from the catalog for the retailer. The query entropy may then be computed as a function of the number of occurrences of the specific action for the different items included in the search results.

For example, the query entropy for a combination of a search query and a retailer is determined as:

$$QE = - {\sum }_{pid} P ( term\_pid \_conversion ) log P ( term\_pid \_conversion )$$

Where: QE is the query entropy,

$$P ( term\_pid \_conversion ) = \frac{count ( term , product\_id )}{count ( term )} ,$$

pid is a unique item identifier for an item in the catalog for a retailer, count(term, product_id) is an number of occurrences of the specific action for a specific item corresponding to product_id resulting from the search query, and count(term) is a total count of performance of the specific action by customers resulting from the search query. Hence, P(term_pid_conversion) represents a likelihood that a customer performed the specific action with an item having item identifier pid from search results corresponding to the search query. The term P(term_pid_conversion)log P(term_pid_conversion) represents an item entropy for a specific item corresponding to item identifier pid, computed as a product of a probability of the customer performing the specific action with the item and a logarithm of the probability of the customer performing the specific action with the item. The query entropy (QE) for the search query is computed as a sum of the item entropies over all unique items in the selected set of items from the catalog for the identified retailer comprising the search results. Hence, the query entropy for the search query provides an indication of the breadth of the set of items selected from the retailer's catalog as search results based on the search query.

One or more item attributes used for determining 335 the position modification of an item of the set are based on a combination of the search query and the item of the set. For example, an item attribute is the relevance score between an item of the set and the search query, as further described above. As another example, an item attribute is an amount of the search query matched by one or more other item attributes, allowing the online concierge system 140 to account for how closely item attributes of the item match the search query when determining 335 the position modification to the item. One or more item attributes of the item itself are used to determine 335 the position modification to the item in various embodiments. For example, an item attribute is a length of time the item has been included in the catalog for the retailer. One or more additional or alternative item attributes are based on a combination of the item and the search query. In some embodiments, one or more item attributes account for prior orders from the customer from whom the search query was received. For example, an item attribute indicates whether the item was previously included in one or more prior orders received from the customer.

In various embodiments, the online concierge system 140 accounts for one or more customer characteristics when determining 335 the position modification to an item identified from the selected set. For example, a customer characteristic identifies a type of customer client device 100 from which the search query was received. The type of customer client device 100 has a first value if the customer client device 100 from which the search query was received is a mobile device and has a second value if the customer client device 100 from which the search query was received is a laptop computer or a desktop computer. This allows a customer characteristic to provide information about an amount of display area available by the customer client device 100 for displaying the set of items. An alternative or additional customer characteristic used to determine 335 the position modification is an amount of time the user has maintained an account with the online concierge system 140. Different or additional customer characteristics may be determined or retrieved in various embodiments to determine 330 the position modification for one or more items.

In various embodiments, the online concierge system 140 determines 335 a position modification for an item of the set by applying a trained position modification model to the item, an indication of a predicted availability of the item, one or more candidate positions of the item in the ranking, and to one or more of the search query attributes, the item attributes, and the user characteristics. In some embodiments, the indication of the predicted availability of the item is an indication that the predicted availability of the item does not exceed a threshold predicted availability, while in other embodiments the indication is the predicted availability of the item determined by the online concierge system 140. In other embodiments, the position modification model does not receive the indication that the predicted availability of the item is less than the threshold predicted availability, with the online concierge system 140 limiting application of the position modification to items identified as having a predicted availability that does not exceed the threshold predicted availability. From the received inputs corresponding to an item (e.g., the search query attributes, the item attributes, the user characteristics, or any combination thereof), the position modification model outputs a probability of the customer including at least one item from the set in an order when the item has the candidate position in a ranking of the set to which the position modification model was applied.

By applying the position modification model to different candidate positions in the ranking and the inputs corresponding to the item, the online concierge system 140 determines a set of probabilities of the customer including at least one item from the set in an order for different positions of the item in a ranking of the set. The candidate positions are each position in the ranking lower than a current position of the item as candidate positions in some embodiments. Alternatively, the candidate positions are positions in the ranking having at least a threshold distance from the current position in the ranking of the item and lower than the current position in the ranking of the item. In various embodiments, the online concierge system 140 determines 335 the position modification for the item as a candidate position corresponding to a maximum probability of the customer including at least one item from the set in an order. This determines 335 a position modification for an item with a predicated availability that does not exceed a threshold predicted availability, so the item has a position in a modified ranking maximizing a probability of the customer including at least one item of the set in an order. By accounting for one or more of the search query attributes, the item attributes, and the customer characteristics, the online concierge system 140 determines 335 different position modifications for different items, different position modifications for an item when displayed to different items, or for different search queries received 315 from customers.

To train the position modification model, the online concierge system 140 generates a training dataset including multiple training examples from previously received search queries and previously fulfilled orders. Each training example includes a position in a ranking of an item of a set of items and one or more of search query attributes for a received search query and item attributes of the item. In some embodiments, each training example also includes one or more customer characteristics. A label indicating whether a customer performed a specific action with at least one item of the set when the item is in the position in the ranking of the set of items is applied to each training example. For example, the label has a first value in response to a customer including at least one item of the set in an order and has a second value in response to a customer not including at least one item of the set in an order. In other embodiments, the value of the label is based on performance of another specific action by a customer with one or more items of the set of items when the item has the position in the ranking. The training examples are determined from previously received search queries received from customers and orders received from the customers after displaying a set of items comprising search results to the customers.

The online concierge system 140 applies the position modification model to each training example of the training dataset. The position modification model determines a predicted probability of a customer performing the specific action with the set of items when an item having item attributes of the training example has a specific position in a ranking of a set of items included in the training example based on a position of the item in a ranking of the set of items and one or more of: search query attributes, item attributes, and customer characteristics. The position modification model comprises a set of weights stored on a non-transitory computer readable storage medium in various embodiments. For training, the online concierge system 140 initializes a network of a plurality of layers comprising the position modification model, with each layer including one or more weights. As described above, the position modification model receives a position of an item in a ranking of a set of items and one or more of: search query attributes, item attributes of the item, and customer characteristics. The position modification model generates a predicted probability of a customer performing the specific action with at least one item of the set of items when the item has the position in the ranking of the set of items. The weights comprise a set of parameters used by the position modification model to transform the input data—the search query attributes of a search query, item attributes of an item, a position of the item in a ranking of a set of items, and customer characteristics—received by the position modification model into output data—the probability of a customer performing the specific action with at least one item in the set of items selected based on a search query having the search query attributes to which the position modification model is applied.

After initializing the set of weights comprising the position modification model, the online concierge system 140 applies the position modification model to multiple training examples of the training dataset to generate the parameters (e.g., the weights) for the position modification model. As further described above, in various embodiments, a training example includes a position of an item in a ranking of a set of items, and one or more of: search query attributes of a search query used to select the set, item attributes of the item, and customer characteristics of a customer from whom the search query was received. A label applied to the training example indicates whether the customer performed a specific action with at least one item of the set of items based on the search query. Applying the position modification model to a training example generates a predicted probability of the customer performing the specific action with at least one item of the set of items when the item having the item attributes has the position in a ranking of the set of items included in the training example.

For each training example to which the position modification model is applied, the online concierge system 140 generates a score comprising an error term based on the predicted probability of the customer performing the specific action with at least one item of the set of items with the item having the position in a ranking of the set of items included in the training example output by the position modification model and the label applied to the training example. The error term is larger when a difference between the predicted probability of the customer performing the specific action with at least one item of the set of items with the item having the position in a ranking of the set of items included in the training example and the label applied to the training example is larger and is smaller when the difference between the predicted probability of the customer performing the specific action with at least one item of the set of items with the item having the position in a ranking of the set of items included in the training example and the label applied to the training example is smaller. In various embodiments, the online concierge system 140 generates the error term using a loss function based on a difference between the predicted probability of the customer performing the specific action with at least one item of the set of items with the item having the position in a ranking of the set of items included in the training example and the label applied to the training example using a loss function. Example loss functions include a mean square error function, a mean absolute error, a hinge loss function, and a cross-entropy loss function.

The online concierge system 140 backpropagates the error term to update the set of parameters comprising the position modification model and stops backpropagation in response to the error term, or to the loss function, satisfying one or more criteria. For example, the online concierge system 140 backpropagates the error term through the position modification model to update parameters of the position modification model until the error term has less than a threshold value. For example, the online system 140 may apply gradient descent to update the set of parameters. The online concierge system 140 stores the set of parameters comprising the position modification model on a non-transitory computer readable storage medium after stopping the backpropagation.

In various embodiments, the online concierge system 140 periodically retrains the position modification model. To retrain the position modification model, the online concierge system 140 generates additional training examples based on search queries and orders received between a time when the online concierge system 140 most recently trained the position modification model and a time when the online concierge system 140 retrains the position modification model. The online concierge system 140 applies the position modification model to each of at least a set of the additional training examples and updates parameters of the position modification model based on predicted probabilities of a customer performing the specific action with at least one item of the set of items with the item having the position in a ranking of the set of items included in additional training examples and labels applied to corresponding additional training examples, as further described above. Periodically retraining the position modification model allows the online concierge system 140 to account for changes over time in actions performed by customers with sets of items displayed in response to search queries.

In various embodiments, different values for different search query attributes, item attributes, or customer characteristics affect a position modification for an item from application of the position modification model to different candidate positions in a ranking for an item. For example, an amount of a position modification is directly related to a query entropy, so a larger query entropy (indicating a broader search query) results in a larger position modification than a smaller query entropy (indicating a more specific search query). As another example, a relevance score of an item to a search query is inversely related to the amount of the position modification for the item, so an item with a higher relevance score to a search query has a smaller position discount than an item with a lower relevance score to the search query. Other potential relationships between values of search query attributes, item attributes, or customer characteristics and a position discount are further described below.

In alternative embodiments, the online concierge system 140 applies one or more rules to values to combinations of one or more of search query attributes, item attributes, and customer characteristics to determine 335 a position modification for an item with a predicted availability that does not exceed the threshold predicted availability. Each rule includes criteria for one or more of search query attributes, item attributes, and customer characteristics and a corresponding position modification for an item when search query attributes, item attributes, or customer characteristics satisfy at least a threshold amount of the criteria in the rule. For example, a position modification included in a rule is applied to an item having an item attribute satisfying one or more criteria when a search query also has a query entropy satisfying one or more criteria in the rule. If a combination of search query attributes, item attributes, or customer characteristics do not satisfy at least a threshold number of criteria in a rule, the position modification specified by the rule is not applied to an item identified by the online concierge system as having a predicted availability that does not exceed the threshold predicted availability.

In various embodiments, different rules specify different position modifications corresponding to different values for one or more search query attributes, one or more item attributes, or one or more customer characteristics. This allows different values for different search query attributes to affect the position modification of an item, allowing different items to have different position discounts based on a search query for which the item was selected. For example, various rules specify a larger position modification when a search query has a higher query entropy (indicating a broad search query) and specify a smaller position modification when the search query has a lower query entropy (indicating a more specific search query). In the preceding example, the relative breadth of the received search query to a catalog for an identified retailer affects an amount by which a position modified affects an item's position in a ranking, with broader search queries causing a larger position modification than more specific search queries.

Similarly, different values for different item attributes affect a position modification for an item. For example, a higher relevance score to the search query causes a smaller position modification for an item while a smaller relevance score to the search query results in a larger position modification for an item. The position modification determination in the preceding example decreases an item's position in the ranking by a greater amount when the item's relevance score to a search query is smaller and decreases the item's position in the ranking by a smaller amount when the item's relevance score to a search query is larger. As another example, an amount of a position modification for an item in the ranking is inversely related to a length of time the item has been included in the catalog for the identified retailer, so an item that has been in the catalog for a shorter amount of time has a larger position modification, while an item that has been in the catalog for a longer amount of time has a smaller position modification. In another example, an item that has one or more item attributes at least partially matching the search query and that was included in one or more prior orders received from the customer has a smaller position modification than the position modification for an item that has one or more item attributes at least partially matching the search query and that was not included in one or more prior orders received from the customer.

Additionally, or alternatively, different values for different customer characteristics affect determination of a position modification for an item with a predicated availability having less than a threshold predicted availability. A customer characteristic indicating the online concierge system 140 received the search query from one or more specific types of customer client device 100 (e.g., types of customer client devices 110 with limited display areas) results in a smaller position modification than a customer characteristic indicating receipt of the search query from one or more alternative types of customer client device 100 (e.g., types of customer client devices 100 with larger display areas). In another example, a customer characteristic identifying a duration that the customer has maintained an account with the online concierge system 140 affects a position modification. For example, a position modification is directly related to an amount of time the customer has maintained an account with the online concierge system 140, so a position modification is smaller when the customer has maintained an account with the online concierge system 140 for a shorter time and is larger when the customer has maintained an account with the online concierge system 140 for a longer time.

After determining 335 the position modification for an item of the set having a predicted availability that does not exceed the threshold predicted availability, the online concierge system 140 modifies 340 the ranking based on the position modification for the item of the set. The online concierge system 140 decreases a position in the ranking of the item by the position modification, generating a modified ranking with the item in a lower position in the ranking determined by the position modification. In some embodiments, the position modification identifies a specific position in the ranking for an item, so the online concierge system 140 reduces the position of the item in the ranking to the specific position. Alternatively, the position modification specifies a number of positions, and the online concierge system 140 modifies 340 the ranking by reducing the position of the item by the specified number of positions. Decreasing the position of the item in the ranking decreases a likelihood of the customer including the item in an order. In various embodiments, the online concierge system 140 modifies 340 the ranking by decreasing positions of each item of the set having less than the threshold predicted availability based on a corresponding position modification.

The online concierge system 140 transmits 345 the modified ranking to the customer client device 100 of the customer for display. The customer client device 100 displays items selected 320 based on the search query in the order specified by the modified ranking. As the modified ranking decreases positions in the ranking for items with predicted availabilities that do not exceed the threshold predicted availability, the modified ranking increases a likelihood of the customer selecting an item with greater than the threshold predicted availability in an order. Such decreased visibility of an item through a lower position in the modified ranking encourages the customer to select an alternative item from the set. As the position modification for an item is based on search query attributes, item attributes, or customer characteristics, different items of the set may have different position modifications, allowing different amounts of reductions for positions of different items in the ranking. This allows the customer to remain able to identify an item having item attributes at least partially matching the search query and with a predicted availability that does not exceed the threshold predicted availability in the selected set of items based on the search query. The variable reduction of different items in the ranking maintains customer confidence in the accuracy of the set of items selected 320 by the online concierge system 140 based on the search query while reducing a likelihood of the customer including an item with less than the threshold predicated availability at the identified retailer in an order.

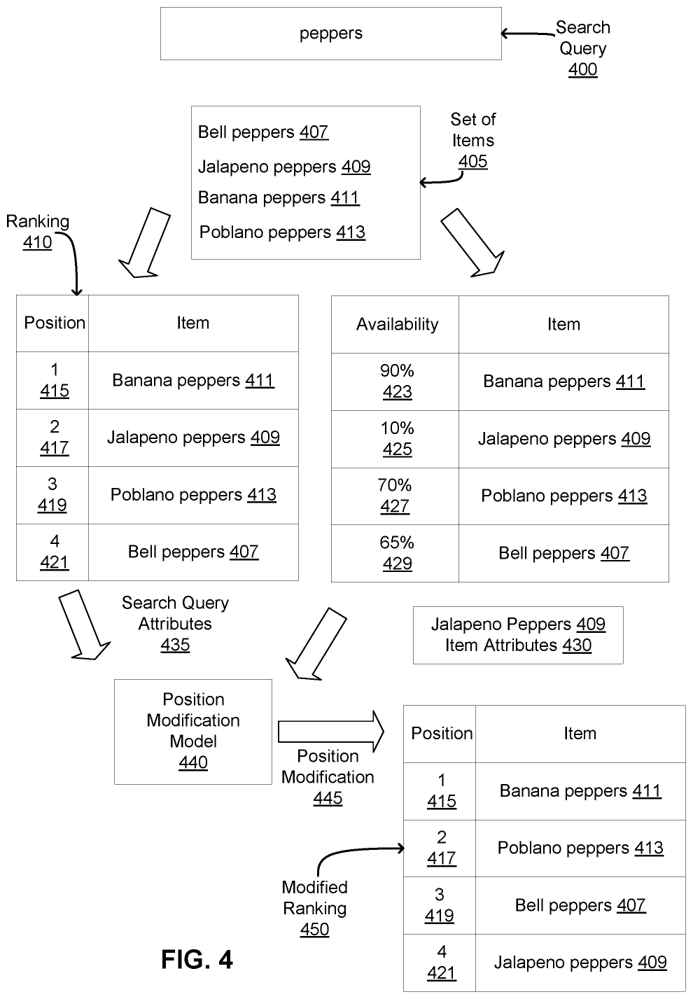

FIG. 4 is a process flow diagram of one or more embodiments of a method for generating search results displaying items offered by a retailer that account for predicted availabilities of items and search query attributes when ranking items in the search results. An online concierge system 140 receives an identifier of a retailer from a customer and retrieves a catalog corresponding to the identified retailer. As further described above in conjunction with FIGS. 2 and 3, the catalog includes items offered by the retailer and includes item attributes for each item offered by the retailer.

After the customer identifies the retailer to the online concierge system 140, the online concierge system 140 receives a search query 400 from the customer. The search query comprises one or more words, phrases, or characters. In some embodiments, the online concierge system 140 receives the search query 400 through an ordering interface presented to the customer in response to the online concierge system 140 receiving a request to create an order for fulfillment at the identified retailer. Alternatively, the online concierge system 140 receives the search query 400 from one or more other interfaces, such as an interface presented to the customer when the online concierge system 140 receives a request from the customer to search an inventory of the identified retailer.

Based on the search query 400, the online concierge system 140 selects a set of items 405. The set of items 405 includes one or more items that each have at least one item attribute at least partially matching the search query 400. In the example of FIG. 4, the search query 400 is the term “peppers,” and each item of the set of items 405 has an item attribute at least partially matching the term “peppers.” The set of items 405 the online concierge system 140 receives in the example of FIG. 4 includes item 407 (“bell peppers”), item 409 (“jalapeno peppers”), item 411 (“banana peppers”), and item 413 (“poblano peppers”). However, the set of items 405 may include any number of items having at least one attribute at least partially matching the search query 400.

While the set of items 405 based on the search query 400 reduces a number of items offered by the retailer presented to the customer based on the search query 400, navigating through the set of items 405 to find or to select a specific item may be time consuming for the customer. To further simplify identification of a specific item in the set of items 405, the online concierge system 140 generates a ranking 410 for the set of items 405. The ranking 410 specifies an order in which items of the set of items 405 are presented when displayed to the customer. The ranking 410 has multiple positions, with each item of the set of items 405 having a position specifying a location in an interface where the item is displayed. In various embodiments, the online concierge system 140 determines the ranking 410 based on a relevance score for each item of the set of items 405 and the search query 400. As further described above in conjunction with FIG. 3, in various embodiments, the ranking score for an item of the set of items 405 is based on one or more of: a probability of the customer including the item in an order, an amount of the search query 400 matched by one or more item attributes, a number of prior orders from the customer including the item, or other information describing the item or interactions by customers with the item. The online concierge system 140 ranks items of the set of items 405 based on their relevance scores, with items having larger ranking scores having higher positions in the ranking 410. This positioning of items in the ranking 410 presents items with higher relevance scores in more prominent positions, reducing an amount of time for the customer to identify those items. In the example of FIG. 4, item 411 has a maximum relevance score and is in a first position 415 of the ranking 410. Item 409 and item 413 are in the second position 417 and the third position 419, respectively, of the ranking 410. In the example of FIG. 4, item 407 has a minimum relevance score and is in the final position 421 of the ranking 410.

While the ranking 410 for the set of items 405 may be based on relevance of different items of the set of items 405, different items have different availabilities at the identified retailer. As the online concierge system 140 fulfills an order from the customer from the identified retailer, availability of an item at the identified retailer affects an ability of the online concierge system 140 to fulfill an order. To account for availability of items when presenting items of the set of items 405 to the customer, the online concierge system 140 determines a predicted availability for each item of the set of items 405. In various embodiments, the online concierge system 140 applies a trained availability model to item attributes of an item, a time when the search query 400 was received, and the identifier of the identified retailer to determine the predicted availability of the item. Alternatively, the online concierge system 140 requests an inventory of an item from the identified retailer when generating the set of items 405 items and receives a current inventory of the item from the identified retailer to determine the predicted availability of the item at the retailer. In the example of FIG. 4, item 411 has predicted availability 423, item 409 has predicted availability 425, item 413 has predicted availability 427, and item 409 has predicted availability 429.

The online concierge system 140 identifies one or more items of the set of items 405 having a predicted availability that does not exceed a threshold predicted availability (or having a predicted availability less than the threshold predicted availability). In various embodiments, the online concierge system 140 determines the threshold predicted availability based on prior feedback from customers for prior orders or based on other suitable information describing user satisfaction or reaction to prior orders. The threshold predicted availability may be specific to the customer from whom the search query was received or may be applicable across global customers of the online concierge system. In the example of FIG. 4, predicted availability 425 of item 409 (“jalapeno peppers”) is less than the threshold predicted availability, while predicted availability 423, predicted availability 427, and predicted availability 429 are greater than the threshold predicted availability. Hence, the online concierge system 140 identifies item 409 in the example of FIG. 4.

To account for predicted availability 425 of item 409 being less than the threshold predicted availability, the online concierge system 140 applies a position modification model 440 to item attributes 430 of item 409 and to search query attributes 435 of search query 400 in the example of FIG. 4. In various embodiments, the position modification model 440 also receives one or more customer characteristics of the customer from whom the search query 400 was received. As further described above in conjunction with FIG. 3, the position modification model 440 is trained to determine the position modification 445 for item 409, which identifies a reduction in a position of item 409 in a ranking of the set of items 405. The position modification model 440 determines a position modification 445 for item 409 in the ranking 410 based on one or more of: the search query attributes 435 of search query 400, the item attributes 435 of item 409, and the customer characteristics of the customer from whom search query 400 was received. The position modification 445 specifies an amount by which the position of item 409 in the ranking is reduced or specifies a modified position in the ranking 410 of item 409 that is less than the current position of item 409 in the ranking 410. Reducing the position of item 409 in the ranking 410 using the position modification 445 makes item 409 more difficult to locate in the ranking 410 for the customer, decreasing a likelihood of the customer including item 409 in an order. This reduces a likelihood of an order from the customer including an item that is likely to be unavailable at the identified retailer.

An example search query attribute 435 received by the position modification model 440 is query entropy of the search query 400 providing a measure of the breadth of the search query 400 relative to a diversity of items included in the catalog for the identified retailer. Other information describing the search query 400 may be alternatively or additionally provided as input to the position modification model 440. Example item attributes of an item to which the position modification model 440 is applied include a relevance score for a combination of the item and the search query 400, a length of time the item has been included in the catalog for the retailer an amount of the search query 400 matched by one or more other item attributes, and an indication whether the item was previously included in one or more prior orders received from the customer. In various embodiments, the position modification model 440 receives one or more customer characteristics as input; example customer characteristics include a type of customer client device 100 from which the search query was received and an amount of time the user has maintained an account with the online concierge system 140. Various combinations of search query attributes, item attributes, and customer characteristics may be received by the position modification model 440 in various embodiments.

Determining the position modification 445 for item 409 based on search query attributes 435, item attributes 430, and customer characteristics, allows the position modification model 440 to determine different position modifications 445 for different items, when different search queries are received, or when different customers provide a search query 400. This dynamic determination of a position modification 445 for an item allows a number of positions an item is reduced in the ranking 410 to vary for different search queries, for different items, or for different customers. Such tailoring of an amount by which an item is decreased in a ranking decreases a likelihood of the customer including the item in an order, while enabling the customer to identify the item within a set of items presented as search results for a search query. Allowing the customer to still locate the item within the set of search results without significant interaction maintains customer confidence in the items selected by the online concierge system 140 for a search query, increasing a likelihood of subsequent interaction with the online concierge system 140 by the customer.

The online concierge system 140 generates a modified ranking 450 by decreasing a position of item 409 from position 417 in the ranking 450 based on the position modification 445. In the example of FIG. 4, the position modification model 440 determines a position modification 445 for item 409 to the last position 42. Hence, the modified ranking 450 of the set of items 405 includes item 409 is in the last position 421 and increases positions of each item below the original position of item 409 (the second position 417 in FIG. 4) relative to the ranking 410. In the example of FIG. 4, the modified ranking 450 has item 411 in the first position 415, item 413 in the second position, item 407 in the third position, and item 409 in the last position 421. The online concierge system 140 transmits the modified ranking 450 to a customer client device 100 of the customer from whom the search query 400 was received, so the set of items 405 selected based on the search query 400 is displayed in an order determined by the modified ranking 450. This allows the customer to identify items expected to be in the set of items 405, while reducing a likelihood of the customer selecting an item with a predicted availability that does not exceed the predicted availability for an order.

While FIG. 4 shows an example where the position modification model 440 determines the position modification 445 for item 409, in other embodiments, the online concierge system 140 determines the position modification 445 by applying one or more rules to combinations of values of the search query attributes 435 for search query 400, the item attributes 430 for item 409, and values of customer characteristics of a customer from whom the search query 400 was received. Different rules include different combinations of values for search query attributes 435, item attributes 430, and customer characteristics, with a rule specifying a position modification 445 corresponding to a particular combination of values for search query attributes 435, item attributes 430, and customer characteristics. As further described above in conjunction with FIG. 3, having different position modifications 445 for different combinations of values for search query attributes 435, item attributes 430, and customer characteristics allows different reductions in position for different items, for different search results, or for different customers. This allows the position modification for an item to be tailored to different circumstances in which the set of items including the item is retrieved. Further, in some embodiments, a model used to determine the ranking 410 of items of the set of items 405 is trained to receive inputs comprising the search query attributes 435 of a search query 400, item attributes 430 of items, and customer characteristics of a customer, as well as other inputs and to determine positions of items of the set of items 405 in the ranking 410 accordingly. In such embodiments, the online concierge system 140 generates a ranking of items of the set that accounts for the search query attributes 435 of a search query 400, item attributes 430 of items, and customer characteristics of a customer when positioning items in the ranking, allowing the initially-generated ranking to position items based on the search query attributes 435 of a search query 400, item attributes 430 of items, and customer characteristics of a customer.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include one or more of: applying the machine learning model to a training example, comparing an output of the machine learning model to the label associated with the training example, or updating weights associated for the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving a search query from a user, at an online system, the search query associated with a retailer;
selecting a set of items from a catalog associated with the retailer based on the search query;
determining a ranking of items of the set based on a relevance score for each item of the set to the search query, the ranking identifying an order in which the items of the set are displayed to the user;
selecting an item of the set having a predicted availability at the retailer that is lower than a threshold predicted availability;
determining a position modification for the selected item based on one or more search query attributes of the search query and one or more item attributes of the received item;
modifying a position of the selected item in the ranking of items based on the determined position modification; and
transmitting the modified ranking of the items to a user client device, the transmitting causing the user device to display the modified ranking of the items for presentation to the user.

2. The method of claim 1, wherein determining the position modification for the selected item based on one or more search query attributes of the search query and one or more item attributes of the received item comprises:
applying a position modification model to each of a set of candidate positions for the selected item, the position modification model determining a probability of the user performing a specific action with at least one item of the set of items based on the search query attributes and the item attributes of the item, the position modification model trained by:
obtaining a training dataset including a plurality of training examples, each training example including a position, search query attributes and item attributes, each training example having a label indicating whether the specific action was performed with at least one item of the set;
applying the position modification model to each training example of the training dataset to generate a predicted probability of the specific action being performed with at least one item of the set corresponding to the position in a training example;
scoring the position modification model using a loss function and the label of the training example; and
updating one or more parameters of the position modification model by backpropagation based on the scoring until one or more criteria are satisfied; and
selecting a position of the set of candidate positions for the selected item based on the probabilities of the specific action being performed with at least one item of the set based on application of the position modification model.

3. The method of claim 2, wherein selecting the position of the set of candidate positions for the selected item based on the probabilities of the specific action being performed with at least one item of the set based on application of the position modification model comprises:
selecting a position of the set of candidate positions corresponding to a maximum probability of the specific action being performed with at least one item of the set.

4. The method of claim 2, wherein determining the probability of the user performing the specific action comprises determining a probability of the user including at least one item of the set in an order.

5. The method of claim 1, wherein determining the position modification for the selected item based on one or more search query attributes of the search query and one or more item attributes of the received item comprises determining the position modification for the selected item based on a search query attribute that comprises a query entropy of the search query that provides a measure of a breadth of the search query relative to a diversity of items included in the catalog for the identified retailer.

6. The method of claim 1, wherein determining the position modification for the selected item based on one or more search query attributes of the search query and one or more item attributes of the received item comprises determining the position modification for the selected item based on one or more item attributes that include one or more of: the relevance score for a combination of the item and the search query, a length of time the item has been included in the catalog for the retailer, an amount of the search query matched by one or more other item attributes of the item, or an indication whether the item was previously included in one or more prior orders received from the user.

7. The method of claim 1, wherein determining the position modification for the selected item based on one or more search query attributes of the search query and one or more item attributes of the received item comprises:
determining the position modification for the selected item based on search query attributes of the search query, one or more item attributes of the received item, and one or more user characteristics of the user.

8. The method of claim 7, wherein one or more user characteristics include one or more of: a type of user client device from which the search query was received, or an amount of time the user has maintained an account with the computing system.

9. The method of claim 1, wherein determining the position modification for the selected item based on one or more search query attributes of the search query and one or more item attributes of the received item comprises:
retrieving a set of rules maintained by the computing system, each rule including a candidate position modification and a corresponding set of criteria for the search query attributes and the one or more item attributes; and
determining the position modification for the identified modification as a candidate position modification included in a rule including at least a threshold amount of criteria satisfied by the search query attributes and the one or more item attributes.

10. A computer program product comprising a non-transitory computer readable storage medium having instructions encoded thereon that, when executed by a processor, cause the processor to perform steps comprising:
receiving a search query from a user, at an online system, the search query associated with a retailer;
selecting a set of items from a catalog associated with the retailer based on the search query;
determining a ranking of items of the set based on a relevance score for each item of the set to the search query, the ranking identifying an order in which the items of the set are displayed to the user;
selecting an item of the set having a predicted availability at the retailer that is lower than a threshold predicted availability;
determining a position modification for the selected item based on one or more search query attributes of the search query and one or more item attributes of the received item;
modifying a position of the selected item in the ranking of items based on the determined position modification; and
transmitting the modified ranking of the items to a user client device, the transmitting causing the user device to display the modified ranking of the items for presentation to the user.

11. The computer program product of claim 10, wherein determining the position modification for the selected item based on one or more search query attributes of the search query and one or more item attributes of the received item comprises:
applying a position modification model to each of a set of candidate positions for the selected item, the position modification model determining a probability of the user performing a specific action with at least one item of the set of items based on the search query attributes and the item attributes of the item, the position modification model trained by:
obtaining a training dataset including a plurality of training examples, each training example including a position, search query attributes and item attributes, each training example having a label indicating whether the specific action was performed with at least one item of the set;
applying the position modification model to each training example of the training dataset to generate a predicted probability of the specific action being performed with at least one item of the set corresponding to the position in a training example;
scoring the position modification model using a loss function and the label of the training example; and
updating one or more parameters of the position modification model by backpropagation based on the scoring until one or more criteria are satisfied; and
selecting a position of the set of candidate positions for the selected item based on the probabilities of the specific action being performed with at least one item of the set based on application of the position modification model.

12. The computer program product of claim 11, wherein selecting the position of the set of candidate positions for the selected item based on the probabilities of the specific action being performed with at least one item of the set based on application of the position modification model comprises:
selecting a position of the set of candidate positions corresponding to a maximum probability of the specific action being performed with at least one item of the set.

13. The computer program product of claim 11, wherein determining the probability of the user performing the specific action comprises determining a probability of the user including at least one item of the set in an order.

14. The computer program product of claim 10, wherein determining the position modification for the selected item based on one or more search query attributes of the search query and one or more item attributes of the received item comprises determining the position modification for the selected item based on a search query attribute that comprises a query entropy of the search query that provides a measure of a breadth of the search query relative to a diversity of items included in the catalog for the identified retailer.

15. The computer program product of claim 10, wherein determining the position modification for the selected item based on one or more search query attributes of the search query and one or more item attributes of the received item comprises determining the position modification for the selected item based on one or more item attributes that include one or more of: the relevance score for a combination of the item and the search query, a length of time the item has been included in the catalog for the retailer, an amount of the search query matched by one or more other item attributes of the item, or an indication whether the item was previously included in one or more prior orders received from the user.

16. The computer program product of claim 10, wherein determining the position modification for the selected item based on one or more search query attributes of the search query and one or more item attributes of the received item comprises:
determining the position modification for the selected item based on search query attributes of the search query, one or more item attributes of the received item, and one or more user characteristics of the user.

17. The computer program product of claim 16, wherein one or more user characteristics include one or more of: a type of user client device from which the search query was received, or an amount of time the user has maintained an account with the online system.

18. The computer program product of claim 10, wherein determining the position modification for the selected item based on one or more search query attributes of the search query and one or more item attributes of the received item comprises:
retrieving a set of rules maintained by the online system, each rule including a candidate position modification and a corresponding set of criteria for the search query attributes and the one or more item attributes; and
determining the position modification for the identified modification as a candidate position modification included in a rule including at least a threshold amount of criteria satisfied by the search query attributes and the one or more item attributes.

19. A system comprising:
a processor; and
a non-transitory computer readable storage medium having instructions encoded thereon that, when executed by the processor, cause the processor to perform steps comprising:
receiving a search query from a user, at an online system, the search query associated with a retailer;
selecting a set of items from a catalog associated with the retailer based on the search query;
determining a ranking of items of the set based on a relevance score for each item of the set to the search query, the ranking identifying an order in which the items of the set are displayed to the user;
selecting an item of the set having a predicted availability at the retailer that is lower than a threshold predicted availability;
determining a position modification for the selected item based on one or more search query attributes of the search query and one or more item attributes of the received item;
modifying a position of the selected item in the ranking of items based on the determined position modification; and
transmitting the modified ranking of the items to a user client device, the transmitting causing the user device to display the modified ranking of the items for presentation to the user.

20. The system of claim 19, wherein determining the position modification for the selected item based on one or more search query attributes of the search query and one or more item attributes of the received item comprises:
applying a position modification model to each of a set of candidate positions for the selected item, the position modification model determining a probability of the user performing a specific action with at least one item of the set of items based on the search query attributes and the item attributes of the item, the position modification model trained by:
obtaining a training dataset including a plurality of training examples, each training example including a position, search query attributes and item attributes, each training example having a label indicating whether the specific action was performed with at least one item of the set;
applying the position modification model to each training example of the training dataset to generate a predicted probability of the specific action being performed with at least one item of the set corresponding to the position in a training example;
scoring the position modification model using a loss function and the label of the training example; and
updating one or more parameters of the position modification model by backpropagation based on the scoring until one or more criteria are satisfied; and
selecting a position of the set of candidate positions for the selected item based on the probabilities of the specific action being performed with at least one item of the set based on application of the position modification model.
